(19) United States
(12) Patent Application Publication
(10) Pub. No.: US 2020/0159260 A1
(43) Pub. Date: May 21, 2020

(54) PART-CIRCULAR VALVE SURFACE FOR WAX VALVE

(71) Applicant: Hamilton Sundstrand Corporation, Charlotte, NC (US)

(72) Inventors: William W. Butcka, Colchester, CT (US); Gary F. D'Angelo, Winsted, CT (US)

(21) Appl. No.: 16/195,306

(22) Filed: Nov. 19, 2018

(51) Int. Cl. G05D 23/02; F16K 1/32

(52) U.S. Cl. CPC G05D 23/022; F16K 1/32

(57) ABSTRACT

A bypass system has a source of a fluid to be cooled and a heat exchanger for selectively cooling the fluid. A bypass valve is mounted on a line to selectively bypass the fluid prior to reaching the heat exchanger. The bypass valve includes a valve poppet, a valve seat, a piston, a valve housing and a wax portion. A piston is moveable along an axis and allows movement of the valve poppet toward and away from the valve seat. The piston moves within a valve housing. A wax portion expands as a temperature increases, and causes the valve poppet to move against the valve seat. The wax portion cools if the temperature lowers such that the valve poppet moves away from the valve seat. There is a sealing surface on the valve poppet in sealing contact with the valve seat. The sealing surface is part-circular in a plane in which the axis lies. A bypass valve is also disclosed.

### BACKGROUND

This application relates to a valve that has a thermally responsive wax plug and wherein a valve poppet has a part-circular surface.

Valves are utilized in any number of modern fluid flow applications. One valve application controls a bypass on a line connecting a fluid to a heat exchanger. If the fluid is below a predetermined temperature, it may be inefficient to send the fluid to the heat exchanger. In such instances, the valve opens to bypass the fluid back to a sump or other source.

One type of valve for providing selective bypass based upon temperature utilizes a wax element that expands when heated. When the wax is heated, it drives a valve poppet against a seat. When the wax cools, it allows a spring assembly to move the valve to a bypass position.

In the prior art valve, there is a frusto-conical shaped valve poppet. This valve poppet is subject to wear.

In addition, the actuation structure for this valve includes a plurality of interacting cylinders and springs. There has been some misalignment between several components as the various members move. This has led to further wear on the valve poppet.

### SUMMARY

A bypass system has a source of a fluid to be cooled and a heat exchanger for selectively cooling the fluid. A bypass valve is mounted on a line to selectively bypass the fluid prior to reaching the heat exchanger. The bypass valve includes a valve poppet, a valve seat, a piston, a valve housing and a wax portion. A piston is moveable along an axis and allows movement of the valve poppet toward and away from the valve seat. The piston moves within a valve housing. A wax portion expands as a temperature increases, and causes the valve poppet to move against the valve seat. The wax portion cools if the temperature lowers such that the valve poppet moves away from the valve seat. There is a sealing surface on the valve poppet in sealing contact with the valve seat. The sealing surface is part-circular in a plane in which the axis lies.

A bypass valve is also disclosed.

These and other features may be best understood from the following drawings and specification.

### BRIEF DESCRIPTION OF THE DRAWINGS

FIG. 1 shows an existing valve.

FIG. 2A shows a first embodiment.

FIG. 2B is a cross-sectional view along line B-B as shown in FIG. 2A.

FIG. 2C is a cross-sectional view along line C-C as shown in FIG. 2A.

FIG. 3 shows yet another embodiment valve.

FIG. 4 is a schematic view of sealing contact.

### DETAILED DESCRIPTION

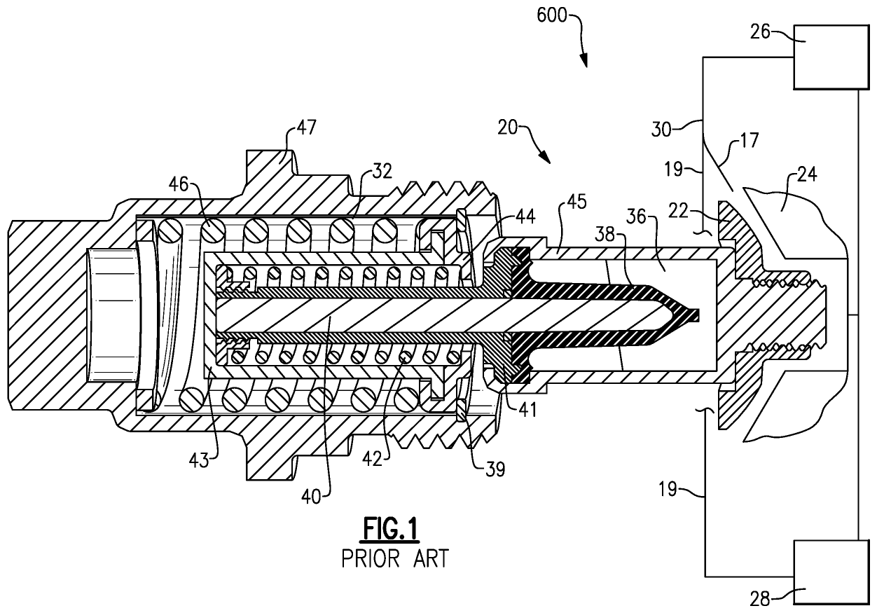

FIG. 1 shows a bypass valve 20 in a bypass system 600. A valve poppet 22 is selectively driven to seat on a valve seat 24. A source 26 selectively communicates a fluid to be cooled to a heat exchanger 28. When the valve poppet 22 is not seated on the seat 24, this fluid is allowed to bypass the heat exchanger 128 and return through line 17 to the source 26.

As shown, the bypass fluid in line 17 communicates with the line 19 which is the normal return line from the heat exchanger 28. These two flows combine into a line 30 heading back to the source 26. The source 26 could be a sump and an item that the oil is cooling such as a generator or other system.

Of course, this explanation is greatly simplified. One such fluid may be oil utilized to cool other components in a gas turbine engine although other bypass applications will benefit from this disclosure. It is only under certain conditions that the oil will reach a temperature where the cooling is necessary. It may be inefficient to cool the fluid at times when it is below a predetermined temperature. Thus, the bypass mode improves the efficiency by bypassing the heat exchanger under most operational conditions.

A valve piston 40 is received within a chamber in a valve housing 45. The valve housing is fixed with the valve poppet. Wax 36 is included in a chamber between the housing 45 and the piston 40, and a rubber boot 38 maintains the wax in the chamber. If the fluid passing towards the heat exchanger 28 exceeds a predetermined temperature, it will heat the valve housing 45 and thus the wax 36. The wax 36 will then expand forcing the piston 40 to the left in the Figure. The piston 40 is received within a piston guide 43. The piston 40 has a forward face 41 secured to the boot 38. The valve guide 43 has a forward face 44. A return spring 42 is in the valve guide 43. Another spring 46 is outward of the valve guide 43 and within an outer housing 47 and provides a pressure relief function. The housing 43 applies a force against the snap ring 39. As the piston 40 moves to the left with the wax 36 being heated, it eventually bottoms out on the bottom of the chamber in the valve guide 43, and forces the valve housing 45 and poppet 22 to the right from the FIG. 1 position.

The wax plug 36 may be a wax and copper powder combination. The inclusion of the copper assists in heat transfer and the melting of the wax to achieve the fine control of the position of the valve 22.

In this prior system, there may be misalignment between the valve guide 43, the outer housing 47, and the piston 40 as the components move. Moreover, the conical sealing surface between valve poppet 22 and seat 24 can result in undue wear, as mentioned above. The wear is also complicated by the misalignment in movement of the several components.

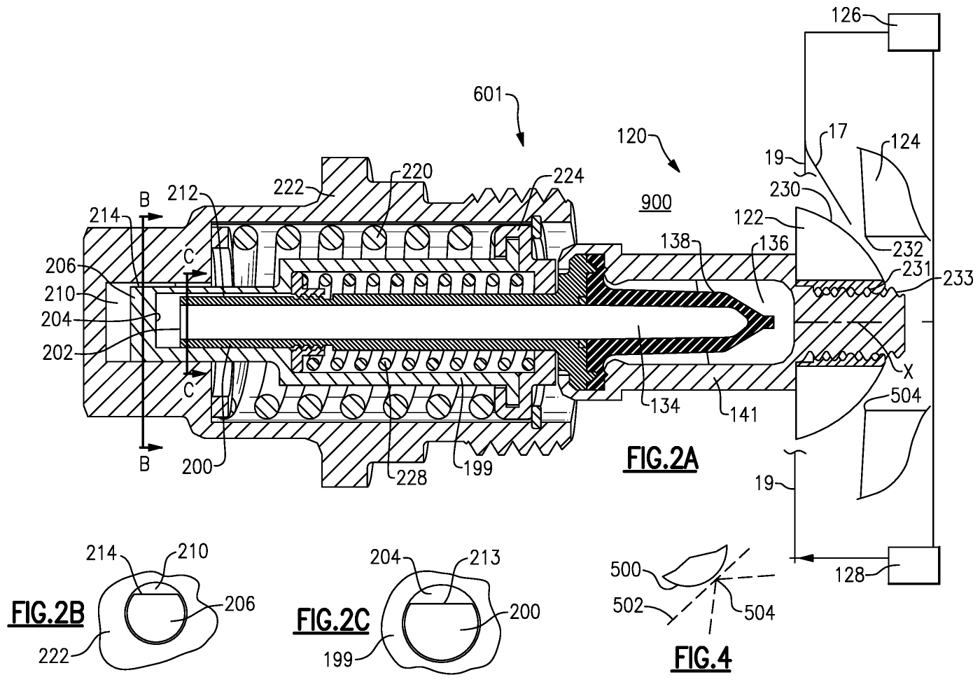

FIG. 2A shows a bypass valve embodiment 120 in a bypass system 601 wherein the valve poppet 122 selectively seats against a valve seat 124. Again, the valve operates to bypass fluid from the source 126 on its way to a heat exchanger 128. The wax 136 operates as described above. The piston 134 moves within a valve housing 141. The piston 134 extends to the left to an extension 200, which is received within a chamber 204 in the piston guide 199.

A flat 212 on the extension 200 allows flow of fluid from a chamber beyond the end 202 of the extension portion 200 to prevent hydraulic lock. However, the remainder of the circumferential surface of portion 200 is guided within chamber 204 to provide guidance for the movement of the piston 134 and the valve housing 141. Similarly, the piston guide 199 has a portion 206 extending into a chamber 210 within an outer housing 222. Another flat 214 allows flow of fluid to prevent hydraulic lock, but otherwise, the portion 206 is guided within the housing portion 210.

FIG. 2B shows the flat 214 and the guidance from the housing chamber 210 for the portion 206. FIG. 2C shows the flat 212 and the piston guide 199 otherwise guiding the extension 200.

The valve poppet 122 has a part spherical outer surface 230 that seats on a break point 232 in the valve seat 124. The combination of the spherical surface seating on a point provides a more reliable seal than in the prior art and reduces wear. As shown, the valve poppet 122 is threaded at 231 to be received on threads 233 on the valve housing 141. This facilitates replacement of the valve poppet 122.

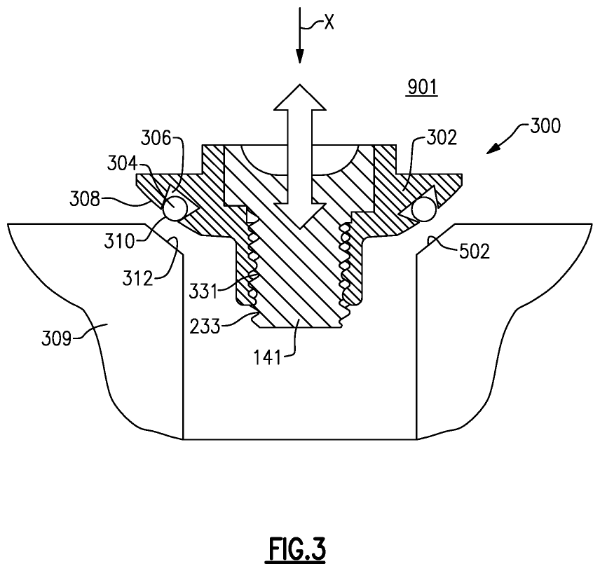

FIG. 3 shows an embodiment 300 wherein the valve poppet 302 has a frusto-conical outer portion 308 that seats against a frusto-conical portion 312 in a valve seat 309. Threads 233 and 331 again secure the valve poppet 302 onto the valve housing 141. However, a groove 306 is formed in the otherwise frusto-conical surface 308 and a cylindrical O-ring 304 is placed within the groove 306. Now, the actual sealing contact will be between the cylindrical seal 310 and the frusto-conical portion 312. Again, a more reliable seal and less damaging wear will be experienced than was the case in the prior art.

FIG. 4 schematically shows the sealing or valve seating in either the FIG. 2A or 3 embodiments. In either there is a part-circular surface 500 that will seat on the valve seat. This may be a conical portion 502 in the FIG. 3 embodiment or a sharp breakpoint 504 as in the FIG. 2A embodiment.

Taking FIGS. 2A, 3 and 4 in combination one could say that there is a sealing surface in each of the FIGS. 2A and 3 embodiments that is part-circular in a plane (900 for FIG. 2A, and 901 for FIG. 3) in which an axis of movement X of the piston lies.

A bypass system under this disclosure could be said to include a source of a fluid to be cooled and a heat exchanger for selectively cooling the fluid. A bypass valve is mounted on a line to selectively bypass the fluid prior to reaching the heat exchanger. The bypass valve includes a valve poppet and valve seat. The valve further includes a piston moveable along an axis and allowing movement of the valve poppet toward and away from the valve seat. The piston moves within a valve housing. A wax portion expands as a temperature increases, to move the piston and causes the valve poppet to move against the valve seat. The wax portion cools if the temperature lowers such that the valve poppet moves away from the valve seat. There is a sealing surface on the valve poppet in sealing contact with the valve seat. The surface is part-circular in a plane in which said axis lies.

Although the bypass valve is disclosed controlling flow to a heat exchanger, other applications may benefit from the disclosed valve.

Although an embodiment of this invention has been disclosed, a worker of ordinary skill in this art would recognize that certain modifications would come within the scope of this disclosure. For that reason, the following claims should be studied to determine the true scope and content of this disclosure.

1. A bypass system comprising:
a source of a fluid to be cooled;
a heat exchanger for selectively cooling the fluid; and
a bypass valve mounted on a line to selectively bypass the fluid prior to reaching the heat exchanger, said bypass valve including a valve poppet, a valve seat, a piston, a valve housing and a wax portion, said piston moveable along an axis allowing movement of said valve poppet toward and away from said valve seat, said piston moving within a valve housing, said wax portion expands as a temperature increases, and causes said valve poppet to move against said valve seat, said wax portion cools if the temperature lowers such that said valve poppet moves away from said valve seat, there being a sealing surface on said valve poppet in sealing contact with said valve seat, said sealing surface being part-circular in a plane in which said axis lies.

2. The bypass system as set forth in claim 1, wherein said valve poppet is part-spherical about said axis.

3. The bypass system as set forth in claim 2, wherein said valve seat has a sharp break point selectively in contact with said valve poppet to provide said seal.

4. The bypass system as set forth in claim 1, wherein said valve poppet has a recess to receive a cylindrical seal with said seal providing said part-circular portion of said valve poppet.

5. The bypass system as set forth in claim 4, wherein said recess is formed in a frusto-conical surface of said valve poppet.

6. The bypass system as set forth in claim 1, wherein said valve poppet is threadably received on threads on said valve housing to facilitate replacement of said valve poppet.

7. The bypass system as set forth in claim 1, wherein said piston having a remote extension guided within a cylinder in a piston guide, a return spring received within said piston guide and said piston guide being received within a cylinder in an outer housing.

8. The bypass system as set forth in claim 7, wherein said outer housing cylinder defining an enlarged portion receiving a second spring, and a smaller chamber for guiding said piston guide extension.

9. The bypass system as set forth in claim 8, wherein said piston guide chamber having an enlarged portion receiving said return spring and a second smaller portion guiding said extension.

10. The bypass system as set forth in claim 9, wherein said extension having a flat to allow leakage of fluid around said extension from said second smaller portion of said piston guide chamber.

11. The bypass system as set forth in claim 10, wherein said piston guide having a flat at an outer peripheral surface at a location which is guided within said smaller chamber in said outer housing to allow leakage of fluid from said smaller chamber around said piston guide.

12. The bypass system as set forth in claim 11, wherein said valve poppet is part-spherical about said axis.

13. The bypass system as set forth in claim 12, wherein said valve seat has a sharp break point selectively in contact with said valve poppet to provide said sealing surface.

14. The bypass system as set forth in claim 11, wherein said valve poppet has a recess to receive a cylindrical seal with said seal providing said part-circular portion of said valve head poppet.

15. The bypass system as set forth in claim 14, wherein said recess is formed in a frusto-conical surface of said valve head poppet.

16. A bypass valve comprising:
a valve poppet; and
a valve seat, a piston, a valve housing, and a wax portion said piston moveable along an axis allowing movement of said valve poppet toward and away from said valve seat, said piston moving within said valve housing, said wax portion expands as a temperature increases, and causes said valve poppet to move against said valve seat, said wax portion cools if a temperature of a wax within the wax portion lowers such that said valve poppet moves away from said valve seat;
there being a sealing surface on said valve poppet in sealing contact with said valve seat said sealing surface being part-circular in a plane in which said axis lies; and
said piston having a remote extension guided within a cylinder in a piston guide, a return spring received within said piston guide and said piston guide being received within a cylinder in an outer housing, said outer housing cylinder defining an enlarged portion receiving a second spring, and a smaller chamber for guiding said piston guide extension, said piston guide chamber having an enlarged portion receiving said guide spring and a second smaller portion guiding said extension, said extension having a flat to allow leakage of fluid around said extension from said second smaller portion of said piston guide chamber, said piston guide having a flat at an outer peripheral surface at a location which is guided within said smaller chamber in said outer housing to allow leakage of fluid from said smaller chamber around said piston guide.

17. The bypass valve as set forth in claim 16, wherein said valve poppet is part-spherical about said axis, and said valve seat has a sharp break point selectively in contact with said valve poppet to provide said seal.

18. The bypass valve as set forth in claim 16, wherein said valve poppet has a recess to receive a cylindrical seal with said seal providing said part-circular portion of said valve poppet.

19. The bypass valve as set forth in claim 18, wherein said recess is formed in a frusto-conical surface of said valve poppet.

20. A bypass system comprising:
a source of a fluid;
a bypass valve mounted on a line to selectively bypass the fluid prior to reaching a downstream component, said bypass valve including a valve poppet a valve seat, a piston, a valve housing and a wax portion, said piston moveable along an axis allowing movement of said valve poppet toward and away from said valve seat, said piston moving within said valve housing, said wax portion expands as a temperature increases, and causes said valve poppet to move against said valve seat, said wax portion cools if the temperature lowers such that said valve poppet moves away from said valve seat; and
there being a sealing surface on said valve poppet in sealing contact with said valve seat and said sealing surface being part-circular in a plane in which said axis lies.
